(19) United States
(12) Patent Application Publication
(10) Pub. No.: US 2020/0103056 A1
(43) Pub. Date: Apr. 2, 2020

(54) ELECTROSTATIC DISSIPATIVE FLUOROPOLYMER COMPOSITES AND ARTICLES FORMED THEREFROM

(71) Applicant: ENTEGRIS, INC., Billerica, MA (US)

(72) Inventors: John P. PUGLIA, Townsend, MA (US); William J. SHANER, Colorado Springs, CO (US); Brett C. Reichow, Chanhassen, MN (US)

(21) Appl. No.: 16/580,210

(22) Filed: Sep. 24, 2019

Related U.S. Application Data
(60) Provisional application No. 62/737,572, filed on Sep. 27, 2018.

(51) Int. Cl. F16L 9/12; B32B 1/08; B32B 27/08; B32B 27/32; F16L 9/133

(52) U.S. Cl. CPC F16L 9/125; B32B 1/08; B32B 27/08; B32B 27/322; B32B 2597/00; B32B 2250/02; B32B 2250/242; B32B 2307/21; F16L 9/133

(57) ABSTRACT

Articles, such as various operative components of a fluid delivery and storage system, incorporating a composite including a fluoropolymer matrix having regions of perfluorinated distributed within the matrix into their construction. The tubing and various operative components incorporating the composite are electrostatic dissipative in nature having a surface resistivity ranging from between 1×10⁴ ohms/square and 1×10¹² ohms/square.

### CROSS-REFERENCE TO RELATED APPLICATION

This application claims priority to and the benefit of U.S. Provisional Application No. 62/737,572 filed Sep. 27, 2018, the entirety of which is incorporated herein by reference for all purposes.

### TECHNICAL FIELD

The disclosure generally relates to a polymeric composition including a fluoropolymer matrix perfluorinated ionomer having electrostatic dissipative properties and articles, including electrostatic dissipative tubing, formed therefrom.

### BACKGROUND

Electrostatic discharge is an important technical issue for fluid delivery and storage systems in the semiconductor industry and in other technology applications. Frictional contact between fluids and surfaces of various operational components (e.g. tubing or piping, valves, fittings, filters, etc.) in the fluid system can result in generation and accumulation of static electrical charges. The extent of charge generation depends on various factors including, but not limited to, the nature of the components and the fluid, fluid velocity, fluid viscosity, electrical conductivity of the fluid, pathways to ground, turbulence and shear in liquids, presence of air in the fluid, and surface area. Further, as the fluid flows through the system, the charge can be carried downstream in a phenomenon called a streaming charge, where charge may accumulate beyond where the charge originated. Sufficient charge accumulations can cause electrostatic discharge at the tubing or pipe walls, component surfaces, or even onto substrates or wafers at various process steps. A continued need exists for mitigating electrostatic discharge in fluid delivery and storage systems.

### SUMMARY

Some embodiments of the disclosure, as described herein, relate to electrostatic dissipative polymeric composites including a fluoropolymer matrix having regions of perfluorinated ionomer distributed within the matrix. Other embodiments relate to electrostatic dissipative tubing incorporating a composite including a fluoropolymer matrix having regions of perfluorinated ionomer distributed within the matrix. Still other embodiments relate to articles, such as various operative components of a fluid handling system, incorporating a composite including a fluoropolymer matrix having regions of perfluorinated ionomer distributed within the matrix into their construction. The tubing and various operative components incorporating the composite are electrostatic dissipative in nature having a surface resistivity ranging from between 1×10⁴ ohms/square and 1×10¹² ohms/square.

Some embodiments of the disclosure, as described herein, relate to a tubing segment. The tubing segment includes a tubing body defining a fluid flow path from a first end of the tubing body to the second end of the tubing body. The tubing body includes a first portion including a non-conductive fluoropolymer and a second portion, in contact with the first portion, the second portion formed from a composite including a fluoropolymer matrix having regions of perfluorinated ionomer distributed throughout the fluoropolymer matrix such that the tubing body has a surface resistivity of between 1×10⁴ ohms/square and 1×10¹² ohms/square. An amount of perfluorinated ionomer in the composite ranges from 0.01 wt. % to 5 wt. % of the total weight of the composite.

In one embodiment, the first portion is an outer layer and defines an outer surface of the tubing body and the second portion is an inner layer and defines an inner surface of the tubing body that comes into contact with a fluid flowing through the fluid flow path.

In another embodiment, the first portion is an inner layer defining an inner surface of the tubing body that comes into contact with a fluid flowing through the fluid flow path and the second portion is an outer layer defining an outer surface of the tubing body, wherein the second layer is disposed over and is in contact with the first layer.

In yet another embodiment, the first portion is an outer layer of the tubing body disposed over and in contact with the second portion forming an inner layer of the tubing body defining an inner surface of the tubing body that comes into contact with a fluid flowing through the fluid path, wherein the first layer includes a one or more conductive stripes extending axially within the first layer in a direction from the first end to the second end of the tubular body.

Some embodiments of the present disclosure, as described herein, relate to an operative component of a fluid delivery and storage system. The operative component includes at least a portion formed from a composite including a fluoropolymer matrix having regions of perfluorinated ionomer distributed throughout the fluoropolymer matrix such that the operative component is electrostatic dissipative and has a surface resistivity of between 1×10⁴ohms/square and 1×10¹² ohms/square. The operative component can be any one of a fitting body, valve body, filter housing, heat exchanger housing, sensors housing, pump body, valve diaphragm, break seal, dispense head, spray nozzle, mixer, container, container liner, or storage drum.

Some embodiments of the present disclosure, as described herein, relate to a composition including a composite including a fluoropolymer matrix having regions of perfluorinated ionomer distributed throughout the matrix, wherein an amount of the perfluorinated ionomer in the composite ranges from 0.01 wt. % to 5 wt. % of the total weight of the composite such that the composite has a surface resistivity of between 1×10⁴ ohms/square and 1×10¹² ohms/square. In one embodiment, the fluoropolymer is perfluoroalkoxy alkane polymer (PFA) and the perfluorinated ionomer is a perfluorinated sulfonic acid copolymer. In certain embodiments, the perfluorinated sulfonic acid copolymer is in acidic form.

Still other embodiments of the disclosure relate to a method including neutralizing a perfluorinated ionomer; blending the neutralized perfluorinated ionomer with a fluoropolymer to form a composite including regions of neutralized perfluorinated ionomer distributed throughout the fluoropolymer; forming a least a portion of an article including the composite; and contacting the article with an acid to convert the neutralized perfluorinated ionomer to an acidic form, wherein the article has a surface resistivity of between 1×10⁴ ohms/square and 1×10¹² ohms/square.

### BRIEF DESCRIPTION OF THE DRAWINGS

The disclosure may be more completely understood in consideration of the following description of various illustrative embodiments in connection with the accompanying drawings

FIG. 1 is a flow chart of a method in accordance with an embodiment of the disclosure.

FIG. 2 is a perspective view of a tubing segment in accordance with various embodiments of the disclosure.

FIGS. 3-7 show cross-sectional views of a tubing segment provided in accordance with various embodiments of the disclosure.

FIG. 8 depicts an operative component in accordance with various embodiments of the disclosure.

FIG. 9 depicts another operative component in accordance with various embodiments of the disclosure.

FIG. 10 depicts yet another operative component in accordance with various embodiments of the disclosure.

While the disclosure is amenable to various modifications and alternative forms, specifics thereof have been shown by way of example in the drawings and will be described in detail. It should be understood, however, that the intention is not to limit aspects of the disclosure to the particular illustrative embodiments described. On the contrary, the intention is to cover all modifications, equivalents, and alternatives falling within the spirit and scope of the disclosure.

### DETAILED DESCRIPTION

The following detailed description should be read with reference to the drawings in which similar elements in different drawings are numbered the same. The detailed description and the drawings, which are not necessarily to scale, depict illustrative embodiments and are not intended to limit the scope of the invention. The illustrative embodiments depicted are intended only as exemplary. Selected features of any illustrative embodiment may be incorporated into an additional embodiment unless clearly stated to the contrary.

According to various embodiments, perfluorinated ionomer particles are blended with a non-conductive fluoropolymer to form a composite including a non-conductive fluoropolymer matrix and regions of perfluorinated ionomer distributed within the non-conductive fluoropolymer matrix. The regions of perfluorinated ionomer within the non-conductive fluoropolymer matrix imparts electrostatic dissipative properties to the resultant composite. An electrostatic dissipative material is a material having a surface resistivity equal to or greater than 1×10⁴ ohms/square but less than 1×10¹² ohms/square or a volume resistivity equal to or granter than 1×10⁴ ohms-cm² but less than 1×10¹¹ ohms-cm². Electrostatic dissipative materials are classified as “antistatic” which is used to describe materials that prevent the buildup of static electricity, which is undesirable in fluid delivery and storage systems used in the semiconductor manufacturing industry.

Exemplary non-conductive fluoropolymers used to form the electrostatic dissipative composite according to the various embodiments can include, but are not limited to, fluoropolymers such as: perfluoroalkoxy alkane polymer (PFA); ethylene and tetrafluoroethylene polymer (ETFE); ethylene, tetrafluoroethylene and hexafluoropropylene polymer (EFEP); and fluorinated ethylene propylene polymer (FEP), all of which are melt-processable. In addition to providing a non-corrosive and inert construction, many fluoropolymers, such as PFA, are injection moldable and extrudable. In one embodiment, the non-conductive fluoropolymer is perfluoroalkoxy alkane polymer (PFA). In other embodiments, the non-conductive fluoropolymer can be polytetrafluoroethylene (PTFE) or tetrafluoroethylene polymer (PTFE) or modified tetrafluoroethylene polymer (TFM), which are not melt-processable, but can be compression molded.

The perfluorinated ionomer particles are blended with the non-conductive fluoropolymer, such as PFA, in an amount effective to impart electrostatic dissipative properties to the composite. Generally, a perfluorinated ionomer is an ionomer that includes a tetrafluoroethylene backbone and a vinyl ether side-chain terminating in an ion-exchange group. The ion-exchange group can be a sulfonic acid group (sulfonate) or a carboxylic acid group (carboxylate). In some cases, the perfluorinated ionomer can include a mixture of sulfonic acid groups and carboxylic acid groups. Due to the presence of the ion-exchange groups, the perfluorinated ionomer is capable of conducting protons and therefore has proton conductivity. However, the perfluorinated ionomer does not conduct anions or electrons.

According to various embodiments, the perfluorinated ionomer can be a perfluorinated sulfonic acid copolymer. An exemplary perfluorinated sulfonic acid copolymer suitable for use in the electrostatic dissipative composite is a perfluorosulfonic acid (PFSA) polymer having a poly(tetrafluoroethylene) backbone with perfluoroether pendant side chains terminated by sulfonic acid groups. An example of one such perfluorosulfonic acid (PFSA) polymer having a poly(tetrafluoroethylene) backbone with perfluoroether pendant side chains terminated by sulfonic acid groups is NAFION™. NAFION™ is a trademark of The Chemours Company. Additional examples of a perfluorosulfonic acid (PFSA) polymer having a poly(tetrafluoroethylene) backbone with perfluoroether pendant side chains terminated by sulfonic acid groups include FLEMION® (Asahi Glass Company), ACIPLEX® (Asahi Kasei), and FUMION® F. (FuMA-Tech).

In one embodiment, the perfluorinated ionomer particles are particles of a perfluorinated sulfonic acid copolymer in its acid (H+) form. NAFION™ particles are one example of particles of a perfluorinated sulfonic acid copolymer in acidic form that can be used to form the electrostatic dissipative composite, as described herein. The perfluorinated sulfonic acid copolymer particles are provided as beads having an average bead size ranging from: 100 nanometers to 1000 nanometers; from 100 nanometers to 500 nanometers; or from 100 nanometers to 200 nanometers. In one embodiment, the perfluorinated sulfonic acid copolymer particles have an average bead size of about 200 nanometers. In some cases, the perfluorinated ionomer particles are available as a suspension in a solvent. In other cases, the perfluorinated ionomer particles are available as dry resin beads.

The perfluorinated sulfonic acid copolymer particles are dispersed within the non-conductive fluoropolymer in an effective amount such that the surface resistivity of the resultant composite ranges from greater than 1×10⁴ ohms/square and less than 1×10¹² ohms/square and more particularly, ranges from 1×10⁵ ohms/square to 1×10⁸ ohms/square. The composite is formed into sheets and surface resistivity measured according to ASTM F1711. In some embodiments, to form the composite, the perfluorinated sulfonic acid copolymer particles are first contacted with a strong base such as ammonium hydroxide or sodium hydroxide to convert the particles from an acid (H+) form of the copolymer to a neutralized or non-ionic form of the copolymer to aid in blending the perfluorinated sulfonic acid copolymer particles with the non-conductive fluoropolymer to form a composite including regions of perfluorinated sulfonic acid copolymer distributed within the non-conductive fluoropolymer matrix. The perfluorinated sulfonic acid copolymer can be converted back to its acidic form after blending by contacting the blended material with a strong acid such as, for example, hydrochloric acid. In one embodiment, an amount of the perfluorinated sulfonic acid copolymer in the composite ranges from 0.01 wt. % to 10 wt. % of the total weight of the composite. In another embodiment, an amount of the perfluorinated sulfonic acid copolymer in the composite ranges from 0.01 wt. % to 5 wt. % of the total weight of the composite. In yet another embodiment, an amount of the perfluorinated sulfonic acid copolymer ranges from 1 wt. % to 5 wt. % of the total weight of the composite. In still another embodiment an amount of the perfluorinated sulfonic acid copolymer ranges from 2 wt. % to 5 wt. % of the total weight of the composite. In some embodiments, the perfluorinated sulfonic acid copolymer is in acid form in the final composite.

In one non-limiting example, an electrostatic dissipative composite includes PFA having regions of NAFION™ in acidic form in an amount ranging from 0.01 wt. % to 5 wt. %, the composite having a surface resistivity of between 1×10⁴ ohms/square and 1×10¹² ohms/square. In another non-limiting example, an electrostatic dissipative composite includes PFA having regions NAFION™ in acidic form in an amount ranging from 2 wt. % to 5 wt. %, the composite having a surface resistivity of between 1×10⁵ ohms/square and 1×10⁸ ohms/square. The composites are formed into sheets and the surface resistivity of the material is measured according to ASTM F1711.

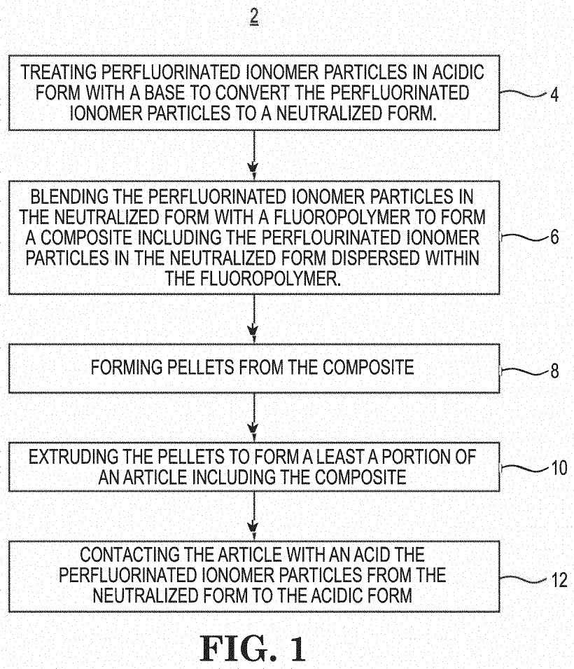

FIG. 1 is a flow chart outlining a method of forming an electrostatic dissipative composite according to the various embodiments, as described herein. In a first step, perfluorinated sulfonic acid copolymer particles are contacted a strong base such as, for example, ammonium hydroxide, to convert the perfluorinated sulfonic acid copolymer particles to their non-ionic or neutralized form (Block 4). In some cases, the perfluorinated sulfonic acid copolymer particles can be provided as a suspension in solvent. Not wishing to be bound by theory, when the perfluorinated sulfonic acid copolymer particles are provided as a suspension, the suspension may be coated onto beads or pellets of the non-conductive fluoropolymer. The solvent is then evaporated leaving behind a coating of the perfluorinated sulfonic acid copolymer on the fluoropolymer beads or pellets. In other cases, perfluorinated sulfonic acid copolymer particles are obtained in the form of a dry powder and are blended with beads or pellets of the non-conductive fluoropolymer to form a starting material. Whatever the method of combining the perfluorinated sulfonic acid copolymer particles with the non-conductive fluoropolymer, the material can be further processed (e.g., melt processed, compression molded, co-extruded, etc.) to form a composite including regions of perfluorinated ionomer in a neutralized form distributed within the fluoropolymer (Block 6). The composite is then formed into pellets (Block 8) which can then be further processed to form an article or portion of an article, as will be described herein. In some cases, depending on the fluoropolymer, the pellets formed from the composite can be extruded, injection molded, rotomolded, blow molded or compression molded to form an article or a portion of an article. In one embodiment, the pellets formed from the composite are extruded to form a tubing segment or one or more layers of a tubing segment (Block 10). In some embodiments, the article formed, at least in part, from the composite is contacted with a strong acid such as, for example, hydrochloric acid, to convert the perfluorinated sulfonic acid copolymer in the composite back to its acid form (Block 12). The number of ion exchange groups in the copolymer that are converted back to the acid or protonated (H+) form may impact the surface resistivity of the resultant article. In some cases, the resultant article has surface resistivity of between 1×10⁴ ohms/square and 1×10¹² ohms/square or more particularly, of between 1×10⁵ ohms/square and 1×10⁸ ohms/square. Surface resistivity of the article can be measured according to ASTM F1711.

In some embodiments, a tubing segment includes an electrostatic dissipative composite, as described herein, such that the tubing segment is electrostatic dissipative having a surface resistivity of between 1×10⁴ ohms/square and 1×10¹² ohms/square or more particularly of between 1×10⁵ ohms/square and 1×10⁸ ohms/square. Incorporation of the electrostatic dissipative material into the tubing segment can reduce the build-up of static charges on the outer surface of the tubing segment as a result of a fluid flowing through the tubing segment. In addition, to the extent that static charges have accumulated on the outer surface of the tubing segment, incorporation of the electrostatic dissipative composite into the tubing segment causes the build-up charges on the outer surface of the tubing segment to more slowly flow to ground. Both the reduction in the accumulation of static charge and the slow transfer of charge to ground may prevent an electrostatic discharge event in a fluid delivery and storage system.

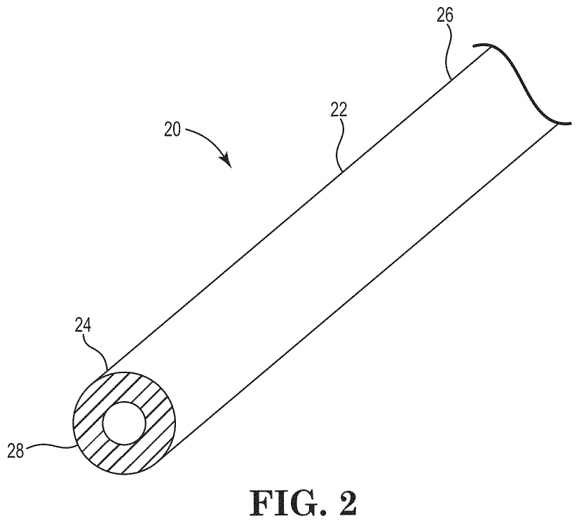

FIG. 2 is a perspective view of a tubing segment in accordance with various embodiments of the disclosure. As shown in FIG. 2, a tubing segment 20 generally includes a tubing body 22 defining a fluid flow path 28 from a first end 24 to a second end 26 of the tubing body 22. According to various embodiments, the tubing body 22 is constructed such that incorporates an electrostatic dissipative composite, as described herein. In certain embodiments, the tubing body 22 forming the tubing segment is constructed entirely from an electrostatic dissipative composite as described herein. The electrostatic dissipative composite used to construct the tubing body 22 imparts electrostatic dissipative properties to the tubing segment 20 which can reduce static charge accumulation on an outer surface of the tubing segment 20 and can mitigate electrostatic discharge. In some embodiments, the tubing segment 20 forms a length of tubing used to a convey a fluid within a larger fluid delivery system. The tubing segment 20 can be of a variety of diameters and lengths depending on the desired application and the nature and volume of fluid to be conveyed within the fluid delivery and storage system. In some cases, the tubing segment is extruded.

The electrostatic dissipative composite used to construct the tubing body 22 includes a PFA matrix having regions of perfluorinated sulfonic acid copolymer distributed throughout the matrix such that the composite has a surface resistivity of between 1×10⁴ ohms/square and 1×10¹² ohms/square. In one embodiment, the perfluorinated sulfonic acid copolymer is NAFION™. The perfluorinated sulfonic acid copolymer can be in acidic form in the final product. The amount of perfluorinated sulfonic acid copolymer in the electrostatic dissipative composite used to form the inner layer 38 can range from: 0.01 wt. % to 10 wt. % of the total weight of the composite; from 0.01 wt. % to 5 wt. % of the total weight of the composite; from 1 wt. % to 5 wt. % of the total weight of the composite; or more particularly, from 2 wt. % to 5 wt. % of the total weight of the composite. The tubing body 22 can have a surface resistivity of between 1×10⁴ ohms/square and 1×10¹² ohms/square or more particularly, of between 1×10⁵ ohms/square and 1×10⁸ ohms/square. Surface resistivity of the tubing body 36 can be measured according to ASTM F1711.

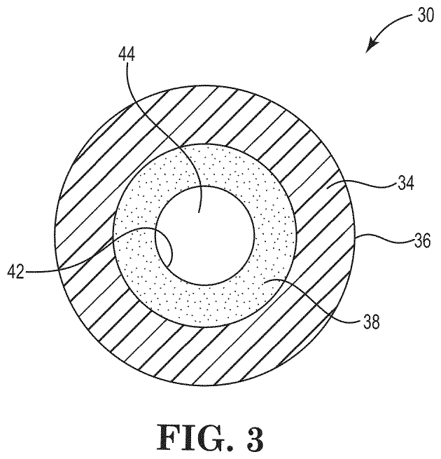

FIG. 3 is a cross-sectional view of a tubing segment 30 according to one embodiment of the disclosure. As shown in FIG. 3, the tubing segment 30 includes a first portion forming an outer layer 34 of the tubing body 36 and a second portion forming an inner layer 38 of the tubing body 36. The outer layer 34 is disposed over and in contact with an outer surface of the inner layer 38. The inner layer 38 defines an inner surface 42 of the tubing body 36 that is exposed to and in contact with a fluid flowing through the fluid flow path 44 defined in the tubing body 36.

In some embodiments, the first portion forming the outer layer 34 of the tubing body is formed from a non-conductive fluoropolymer. Suitable non-conductive fluoropolymers used to form the outer layer include, but are not limited to, fluoropolymers such as: perfluoroalkoxy alkane polymer (PFA); ethylene and tetrafluoroethylene polymer (ETFE); ethylene, tetrafluoroethylene and hexafluoropropylene polymer (EFEP); and fluorinated ethylene propylene polymer (FEP). In one embodiment, the first portion forming the outer layer 34 is formed from PFA.

The second portion forming the inner layer 38 defining an inner surface 42 of the tubing body 36 can be formed form an electrostatic dissipative composite including a non-conductive fluoropolymer matrix having regions of perfluorinated ionomer distributed throughout the matrix. In some embodiments, the electrostatic dissipative composite includes a PFA matrix having regions of perfluorinated sulfonic acid copolymer distributed throughout the matrix such that the composite has a surface resistivity of between 1×10⁴ ohms/square and 1×10¹² ohms/square. In one embodiment, the perfluorinated sulfonic acid copolymer is NAFION™. The perfluorinated sulfonic acid copolymer can be in acidic form in the final product. The amount of perfluorinated sulfonic acid copolymer in the electrostatic dissipative composite used to form the inner layer 38 can range from: 0.01 wt. % to 10 wt. % of the total weight of the composite; from 0.01 wt. % to 5 wt. % of the total weight of the composite; from 1 wt. % to 5 wt. % of the total weight of the composite; or more particularly, from 2 wt. % to 5 wt. % of the total weight of the composite. The tubing body 36 can have a surface resistivity of between 1×10⁴ ohms/square and 1×10¹² ohms/square or more particularly, of between 1×10⁵ ohms/square and 1×10⁸ ohms/square. Surface resistivity of the tubing body 36 can be measured according to ASTM F1711.

In one embodiment, the outer layer 34 can be co-extruded with the inner layer 38 to form the tubing body 36. In another embodiment, the inner layer 38 can be formed first by extrusion. The outer layer 34 can then be extruded over the inner layer 38 to form the tubing body 36.

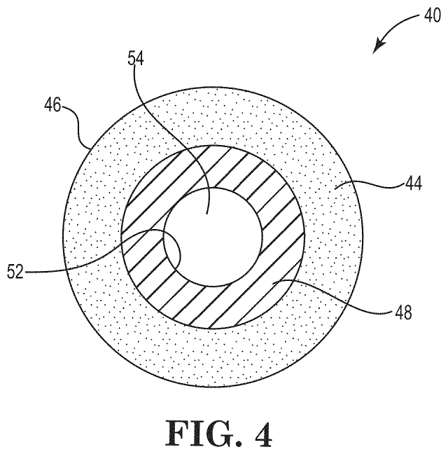

FIG. 4 is cross-section view of a tubing segment 40 in accordance with another embodiment of the disclosure. As shown in FIG. 4, the tubing segment 40 includes a first portion forming an outer layer 44 of the tubing body 46 and a second portion forming an inner layer 48 of the tubing body 46. The outer layer 44 is disposed over and in contact with an outer surface of the inner layer 48. The inner layer 48 defines an inner surface 52 of the tubing body 46 that is exposed to and in contact with a fluid flowing through the fluid flow path 54 defined in the tubing body 46.

The first portion forming the outer layer 44 of the tubing body 46 can be formed form an electrostatic dissipative composite including a fluoropolymer blended with perfluorinated ionomer particles, as described herein. In some embodiments, the electrostatic dissipative composite includes a PFA matrix having regions of perfluorinated sulfonic acid copolymer distributed throughout the matrix such that the composite has a surface resistivity of between 1×10⁴ ohms/square and 1×10¹² ohms/square. In one embodiment, the perfluorinated sulfonic acid copolymer is NAFION™. The perfluorinated sulfonic acid copolymer can be in acidic form in the final product. The amount of perfluorinated sulfonic acid copolymer in the electrostatic dissipative composite used to form the outer layer 44 can range from: 0.01 wt. % to 10 wt. % of the total weight of the composite; from 0.01 wt. % to 5 wt. % of the total weight of the composite; from 1 wt. % to 5 wt. % of the total weight of the composite; or more particularly, from 2 wt. % to 5 wt. % of the total weight of the composite. The tubing body 46 can have a surface resistivity of between 1×10⁴ ohms/square and 1×10¹² ohms/square or more particularly, of between 1×10⁵ ohms/square and 1×10⁸ ohms/square. Surface resistivity of the tubing body 46 is measured according to ASTM F1711.

The second portion forming the inner layer 48 of the tubing body 46 can be formed from a non-conductive fluoropolymer. Suitable non-conductive fluoropolymers used to form the inner layer include, but are not limited to, fluoropolymers such as: perfluoroalkoxy alkane polymer (PFA); ethylene and tetrafluoroethylene polymer (ETFE); ethylene, tetrafluoroethylene and hexafluoropropylene polymer (EFEP); and fluorinated ethylene propylene polymer (FEP). In one embodiment, the second portion forming the inner layer 48 is formed from PFA.

In one embodiment, the outer layer 44 can be co-extruded with the inner layer 48 to form the tubing body 46. In another embodiment, the inner layer 48 can be formed first by extrusion. The outer layer 44 can then be extruded over the inner layer 48 to form the tubing body 46.

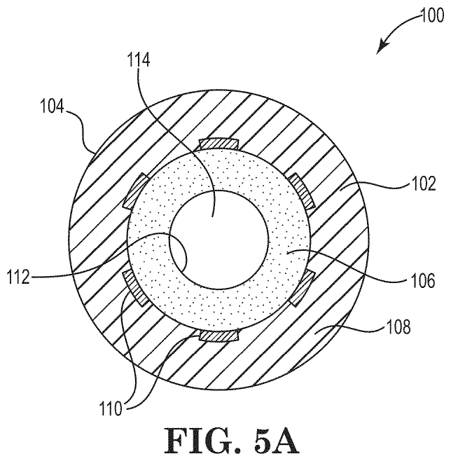

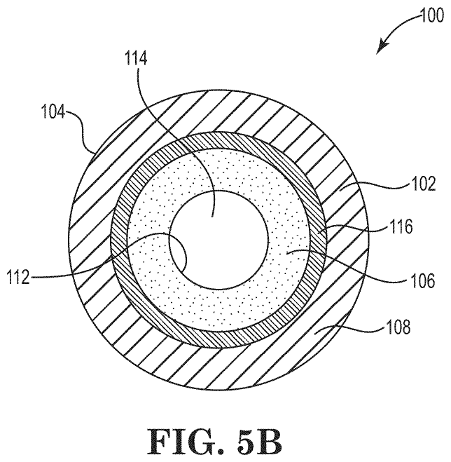

FIGS. 5A and 5B show a cross-sectional view of a tubing segment 100 according to still other embodiments of the disclosure. As shown in FIG. 5A, the tubing segment 100 includes a first portion forming an outer layer 102 of the tubing body 104 and a second portion forming an inner layer 106 of the tubing body 104. As show in FIG. 5A, the first portion forming the outer layer 102 includes a primary, non-conductive portion 108 and at least one secondary, conductive portion formed as a stripe 110 of conductive materially extending axially on or within the main, non-conductive portion 108. In the embodiment depicted in FIG. 5A, the primary, non-conductive portion 108 forming at least a portion of the outer layer 102 (FIG. 5A) is formed from a non-conductive fluoropolymer such as those described herein, and the stripe or stripes 110 of conductive material are formed from a fluoropolymer that is loaded with a conductive material. One non-limiting example of a fluoropolymer that is loaded with a conductive material is carbon-loaded PFA.

In other embodiments, as depicted in FIG. 5B, the secondary, conductive portion can be provided as an intermediate, conductive layer 116 disposed between the non-conductive portion 108 and the inner layer 106. As shown in FIG. 5B, the non-conductive portion 108 forms the entire outer layer 102 and is formed from a non-conductive fluoropolymer such as those described herein. The intermediate, conductive layer 116 can be formed from a fluoropolymer that is loaded with a conductive material such as, for example, carbon-loaded PFA. This is just one example. It is to be understood that other conductive-filled polymers, in particular fluoropolymers, can be used to form the intermediate conductive layer 116.

The second portion forming the inner layer 106 of the tubing body 104 shown in FIGS. 5A and 5B can be formed form an electrostatic dissipative composite including a fluoropolymer blended with perfluorinated ionomer particles, as described herein. In some embodiments, the electrostatic dissipative composite includes PFA matrix having regions of perfluorinated sulfonic acid copolymer distributed throughout the matrix such that the composite has a surface resistivity of between 1×10⁴ ohms/square and 1×10¹² ohms/square. In one embodiment, the perfluorinated sulfonic acid copolymer is NAFION™. The perfluorinated sulfonic acid copolymer can be in acidic form in the final product. The amount of perfluorinated sulfonic acid copolymer in the electrostatic dissipative composite used to form the inner layer 106 can range from: 0.01 wt. % to 10 wt. % of the total weight of the composite; from 0.01 wt. % to 5 wt. % of the total weight of the composite; from 1 wt. % to 5 wt. % of the total weight of the composite; or more particularly, from 2 wt. % to 5 wt. % of the total weight of the composite. The tubing body 104 can have a surface resistivity of between 1×10⁴ ohms/square and 1×10¹² ohms/square or more particularly, of between 1×10⁵ ohms/square and 1×10⁸ ohms/square. Surface resistivity of the tubing body is measured according to ASTM F1711.

In addition to imparting electrostatic dissipative properties to the tubing body 104, the presence of the inner layer 106 formed from the electrostatic dissipative composite may also provide a more inert inner surface 112 for contact with a fluid flowing through a fluid flow path 114 defined in the tubing body 104, and may also prevent contaminants from the conductive stripes 110 being introduced into the fluid.

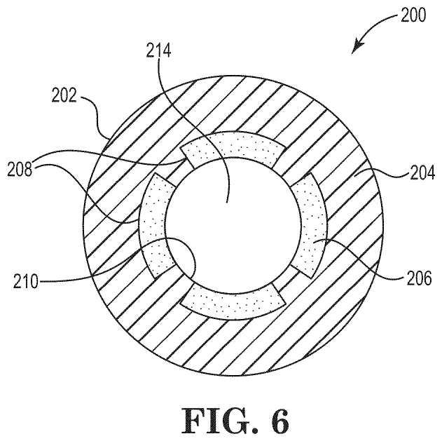

FIG. 6 shows an end cross-sectional view of another exemplary embodiment of a tubing segment 200 having a tubing body 202 including a first portion 204 and a second portion 206 formed as one or more stripes 208 extending axially on or within the first portion 204 of the tubing body 202. Together, the first portion 204 and the second portion 206 can define an inner surface 210 tubing body 202 that is exposed to and in contact with a fluid flowing through the fluid flow path 214 defined in the tubing body 202. The number of stripes 208 can vary. In some embodiments, the tubing body 202 can include a fewer or greater number of stripes 208 than depicted in FIG. 6.

The first portion 204 of the tubing body 202 can be formed from a non-conductive fluoropolymer. Suitable non-conductive fluoropolymers used to form the outer layer include, but are not limited to, fluoropolymers such as: perfluoroalkoxy alkane polymer (PFA); ethylene and tetrafluoroethylene polymer (ETFE); and ethylene, tetrafluoroethylene and hexafluoropropylene polymer (EFEP); and fluorinated ethylene propylene polymer (FEP). In one embodiment, the first portion 204 is formed from PFA.

The second portion 206 of the tubing body 202 can be formed form an electrostatic dissipative composite including a fluoropolymer blended with perfluorinated ionomer particles, as described herein. In some embodiments, the electrostatic dissipative composite includes a PFA matrix having regions of perfluorinated sulfonic acid copolymer distributed throughout the matrix such that the composite has a surface resistivity of between 1×10⁴ ohms/square and 1×10¹² ohms/square. In one embodiment, the perfluorinated sulfonic acid copolymer is NAFION™. The perfluorinated sulfonic acid copolymer can be in acidic form in the final product. The amount of perfluorinated sulfonic acid copolymer in the electrostatic dissipative composite used to form the inner layer 38 can range from: 0.01 wt. % to 10 wt. % of the total weight of the composite; from 0.01 wt. % to 5 wt. % of the total weight of the composite; from 1 wt. % to 5 wt. % of the total weight of the composite; or more particularly, from 2 wt. % to 5 wt. % of the total weight of the composite. The tubing body 202 can have a surface resistivity of between 1×10⁴ ohms/square and 1×10¹² ohms/square or more particularly, of between 1×10⁵ ohms/square and 1×10⁸ ohms/square. Surface resistivity of the tubing body is measured according to ASTM F1711.

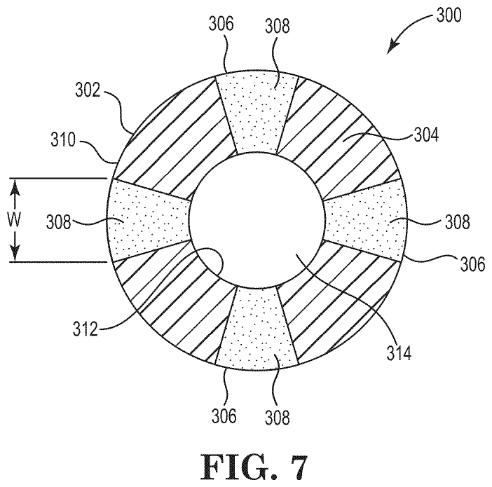

FIG. 7 shows an end cross-sectional view of another exemplary embodiment of a tubing segment 300 having a tubing body 302 including a first portion 304 and a second portion 306 formed as one or more stripes 308 extending in an axial direction within the first portion 304 along a length of the tubing body 302. In addition to extending in an axial direction within the first portion 304 along a length of the tubing body 302, the one or more stripes 308 have a thickness extending through the first portion 304 from an outer surface 310 to an inner surface 312 of the tubing body 302. Together, the first portion 304 and the one or more stripes 308 forming the second portion 306 can define the inner surface 312 tubing body 302 that is exposed to and in contact with a fluid flowing through a fluid flow path 314 defined in the tubing body 302. The number of stripes 308 can vary. In some embodiments, the tubing body 302 can include a fewer or greater number of stripes 308 than depicted in FIG. 7. The width, w, of the stripes 308 can also vary.

The first portion 304 of the tubing body 302 can be formed from a non-conductive fluoropolymer. Suitable non-conductive fluoropolymers used to form the outer layer include, but are not limited to, fluoropolymers such as: perfluoroalkoxy alkane polymer (PFA); ethylene and tetrafluoroethylene polymer (ETFE); ethylene, tetrafluoroethylene and hexafluoropropylene polymer (EFEP); and fluorinated ethylene propylene polymer (FEP). In one embodiment, the first portion 304 is formed from PFA.

The stripes 308 forming the second portion 306 of the tubing body 302 can be formed form an electrostatic dissipative composite including a fluoropolymer blended with perfluorinated ionomer particles, as described herein. The fluoropolymer used to form the composite can be the same fluoropolymer used to form the first portion 304 of the tubing body 302, but this is not required. In some embodiments, the electrostatic dissipative composite includes a PFA matrix having regions of perfluorinated sulfonic acid copolymer distributed throughout the matrix such that the composite has a surface resistivity of between 1×10⁴ ohms/square and 1×10¹² ohms/square. In one embodiment, the perfluorinated sulfonic acid copolymer is NAFION™. The perfluorinated sulfonic acid copolymer can be in acidic form in the final product. The amount of perfluorinated sulfonic acid copolymer in the electrostatic dissipative composite used to form the inner layer 38 can range from: 0.01 wt. % to 10 wt. % of the total weight of the composite; from 0.01 wt. % to 5 wt. % of the total weight of the composite; from 1 wt. % to 5 wt. % of the total weight of the composite; or more particularly, from 2 wt. % to 5 wt. % of the total weight of the composite. The tubing body 302 can have a surface resistivity of between 1×10⁴ ohms/square and 1×10¹² ohms/square or more particularly, of between 1×10⁵ ohms/square and 1×10⁸ ohms/square. Surface resistivity of the tubing body is measured according to ASTM F1711.

In addition to tubing segments, at least a portion of various other operative components of a fluid delivery and storage system can be formed from an electrostatic dissipative composite, as disclosed herein according to the various embodiments. The term “operative component” as used herein in this disclosure refers to any component or device having a fluid input and a fluid output and that connect with tubing segments for directing or providing for the flow of fluid. The term “operative component” also includes operative parts of a component that are exposed to or in contact with a fluid such as, for example, a valve, pump diaphragm or a break seal. Examples of operative components include, but are not limited to, fitting bodies, valve bodies, valve diaphragms, filter housings, heat exchanger housing, sensor housings, pump bodies, diaphragms, break seals, dispense heads, spray nozzles, mixers, containers, container liners, storage drums, and/or the like. In one embodiment, the operative component is a valve body or a pump body. In another embodiment, the operative component is a valve diaphragm or a pump diaphragm. In some cases, at least a portion, if not all, of the operative component can be compression molded from the composite.

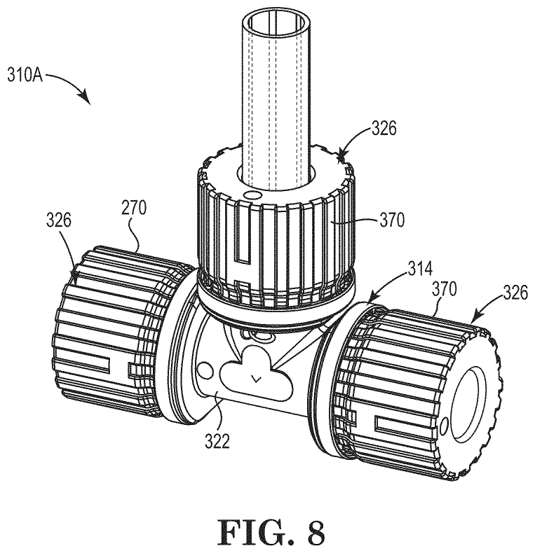

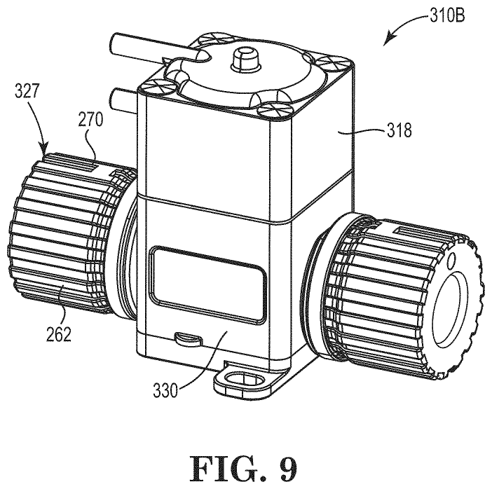

FIGS. 8 and 9 depict examples of operative components 310A, 310B according to one or more embodiments of this disclosure. FIG. 8 depicts an operative component 310A that is a fitting 314, and, more specifically, is a three-way connector having a “T” shape (e.g. a T-shaped fitting). FIG. 9 depicts a valve 318. The T-shaped fitting 314 includes a body portion 322 and three connector fittings 326 extending outwardly from the body portion 322. In certain embodiments, the exterior surface of the connector fittings includes a structure surface 370. The valve 318 includes a body portion 330 and two connector fittings 327 extending outwardly from the body portion 330. In certain embodiments, the exterior surface of the connector fittings includes a structure surface 370.

In various embodiments, connector fittings 326 and 327 have substantially the same design. As described above, in various embodiments the body portion 322, 330 is constructed using an electrostatic dissipative composite as described herein. For example, at least a portion of the body portion 322 or 330 can be constructed from an electrostatic dissipative composite including a PFA matrix having regions of blended perfluorinated sulfonic acid copolymer distributed throughout the matrix. In one embodiment, the perfluorinated sulfonic acid copolymer is NAFION™. The perfluorinated sulfonic acid copolymer can be in acidic form in the final product. The amount of perfluorinated sulfonic acid copolymer in the electrostatic dissipative composite used to form at least a portion of the body portion 322 or 330 can range from: 0.01 wt. % to 10 wt. % of the total weight of the composite; from 0.01 wt. % to 5 wt. % of the total weight of the composite; from 1 wt. % to 5 wt. % of the total weight of the composite; or more particularly, from 2 wt. % to 5 wt. % of the total weight of the composite. The operative component formed from the composite can have a surface resistivity of between 1×10⁴ ohms/square and 1×10¹² ohms/square or more particularly, of between 1×10⁵ ohms/square and 1×10⁸ ohms/square. Surface resistivity is measured according to ASTM F1711.

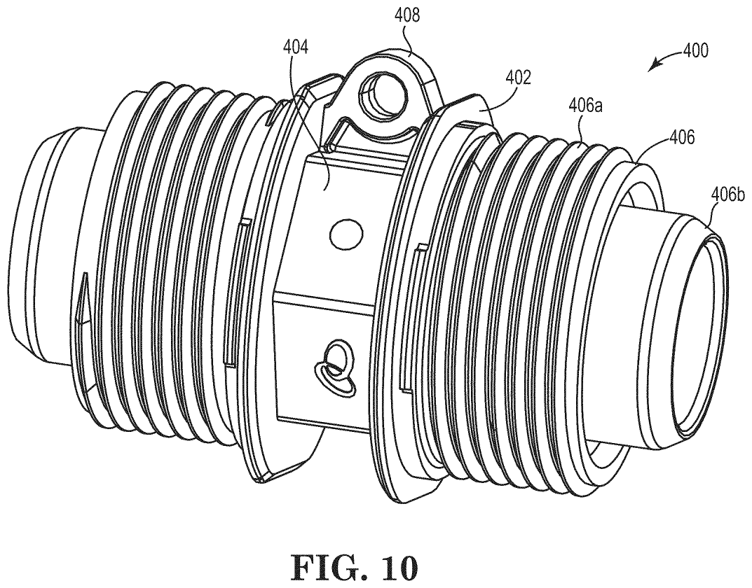

FIG. 10 depicts yet another operative component 400, at least a portion of which can be formed from an electrostatic dissipative composite as described herein. FIG. 10 illustrates a straight connector fitting 400 to connect two tubing segments. Connector fitting 400 includes a shoulder region 402 adjacent a body portion 404 of an operative component and extends outwardly to form a neck region 406, a threaded region 406a, and a nipple portion 406b. A tubing segment, such as described herein accord to the various embodiments, can be received by the nipple portion 406b, which may be configured, for example, as a PRIMELOCK® fitting. PRIMELOCK® is a registered trademark of Entegris, Inc. In certain embodiments, connector fitting 400 includes an attachment feature 408 that is formed from an electrostatic dissipative composite, as described herein, and that is connected with the body portion 404 for attachment to an external electrical contact and then to ground. For example, attachment feature 408 can be connected to an electrical contact which is grounded in order to configure the operative component connector fitting 400 for ESD mitigation. For example, at the attachment feature 408 and/or the body portion 404 can be constructed from an electrostatic dissipative composite including a PFA matrix having regions of blended perfluorinated sulfonic acid copolymer distributed throughout the matrix. In one embodiment, the perfluorinated sulfonic acid copolymer is NAFION™. The perfluorinated sulfonic acid copolymer can be in acidic form in the final product. The amount of perfluorinated sulfonic acid copolymer in the electrostatic dissipative composite used to form at least a portion of the attachment feature 408 and/or the body portion 404 can range from: 0.01 wt. % to 10 wt. % of the total weight of the composite; from 0.01 wt. % to 5 wt. % of the total weight of the composite; from 1 wt. % to 5 wt. % of the total weight of the composite; or more particularly, from 2 wt. % to 5 wt. % of the total weight of the composite. The attachment feature 408 and/or body portion 404 formed from the composite can have a surface resistivity of between 1×10⁴ ohms/square and 1×10¹² ohms/square or more particularly, of between 1×10⁵ ohms/square and 1×10⁸ ohms/square. Surface resistivity is measured according to ASTM F1711.

Having thus described several illustrative embodiments of the present disclosure, those of skill in the art will readily appreciate that yet other embodiments may be made and used within the scope of the claims hereto attached. Numerous advantages of the disclosure covered by this document have been set forth in the foregoing description. It will be understood, however, that this disclosure is, in many respects, only illustrative. Changes may be made in the details, particularly in matters of shape, size, and arrangement of parts without exceeding the scope of the disclosure. The disclosure's scope is, of course, defined in the language in which the appended claims are expressed.

What is claimed is:

1. A tubing segment comprising:
a tubing body defining a fluid flow path from a first end of the tubing body to the second end of the tubing body, wherein the tubing body includes a first portion including a non-conductive fluoropolymer and a second portion, in contact with the first portion, the second portion formed from a composite including a fluoropolymer matrix having regions of perfluorinated ionomer distributed throughout the fluoropolymer matrix,
wherein the tubing body has a surface resistivity of between 1×10⁴ ohms/square and 1×10¹² ohms/square.

2. The tubing segment according to claim 1, wherein an amount of perfluorinated ionomer in the composite ranges from 0.01 wt. % to 5 wt. % of the total weight of the composite.

3. The tubing segment according to claim 1, wherein the fluoropolymer is perfluoroalkoxy alkane polymer and the perfluorinated ionomer comprises a perfluorinated sulfonic acid copolymer.

4. The tubing segment according to claim 3, wherein the perfluorinated sulfonic acid copolymer is in acidic form.

5. The tubing segment according to claim 1, wherein the first portion is an outer layer and defines an outer surface of the tubing body and the second portion is an inner layer and defines an inner surface of the tubing body that comes into contact with a fluid flowing through the fluid flow path.

6. The tubing segment according to claim 1, wherein the first portion is an inner layer defining an inner surface of the tubing body that comes into contact with a fluid flowing through the fluid flow path and the second portion is an outer layer defining an outer surface of the tubing body, wherein the second layer is disposed over and is in contact with the first layer.

7. The tubing segment according to claim 1, wherein the first portion is an outer layer of the tubing body disposed over and in contact with the second portion forming an inner layer of the tubing body defining an inner surface of the tubing body that comes into contact with a fluid flowing through the fluid path, wherein the first layer includes a one or more conductive stripes extending axially within the first layer in a direction from the first end to the second end of the tubular body.

8. The tubing segment according to claim 1, wherein the second portion comprises one or more stripes of the composite extending within in the first portion in an axial direction along the length of the tubing body.

9. The tubing segment according to claim 8, wherein the one or more stripes having a thickness extending from an outer surface to an inner surface of the tubing body.

10. A tubing segment comprising: a tubing body defining a fluid flow path from a first end to a second end of the tubing body, the tubing body constructed entirely from a composite including a fluoropolymer matrix having regions of perfluorinated ionomer distributed throughout the fluoropolymer matrix such that the operative component is electrostatic dissipative and has a surface resistivity of between 1×10⁴ ohms/square and 1×10¹² ohms/square.

11. An operative component comprising: at least a portion formed from a composite including a fluoropolymer matrix having regions of perfluorinated ionomer distributed throughout the fluoropolymer matrix such that the operative component is electrostatic dissipative and has a surface resistivity of between 1×10⁴ ohms/square and 1×10¹² ohms/square.

12. The operative component according to claim 11, wherein the operative component is any one of a fitting body, valve body, filter housing, heat exchanger housing, sensor housing, pump body, valve diaphragm, break seal, dispense head, spray nozzle, mixer, container, container liner, or storage drum.
